(19) United States
(12) Patent Application Publication
(10) Pub. No.: US 2018/0154551 A1
(43) Pub. Date: Jun. 7, 2018

(54) CORE DRILL BIT ASSEMBLY

(71) Applicants: SAINT-GOBAIN ABRASIVES, INC., Worcester, MA (US); SAINT-GOBAIN ABRASIFS, Conflans-Sainte-Honorine (FR)

(72) Inventors: Unnikrishnan PAINUMGAL, Chennai (IN); Naresh SAHA, Chennai (IN)

(21) Appl. No.: 15/829,473

(22) Filed: Dec. 1, 2017

(30) Foreign Application Priority Data
Dec. 2, 2016 (IN) 201641041246

(51) Int. Cl. B28D 1/04

(52) U.S. Cl. CPC B28D 1/041

(57) ABSTRACT

A core drill bit assembly is disclosed and includes a shank in which a support sleeve can be removably engage. A core tube can be installed around the support sleeve within the shank. The core tube is removably engaged with the shank and the support sleeve.

### CROSS-REFERENCE TO RELATED APPLICATION

The present application claims priority under 35 U.S.C. § 119(a)-(d) to Indian Patent Application No. 201641041246, filed Dec. 2, 2016, entitled “CORE DRILL BIT ASSEMBLY,” naming as inventors Unnikrishnan PAINUMGAL et al., which application is assigned to the current assignee hereof and is incorporated by reference herein in its entirety.

### BACKGROUND OF THE INVENTION

### Field of the Disclosure

The present invention relates, in general, to core drill bits and multi-piece core drill bit assemblies.

### Description of the Related Art

Core drill bits can be used to generate holes in materials. In applications of drilling brittle materials, such as glass, chipped areas are often formed around edges of drilled holes, due to lack of better control over formation of edges during drilling and nature of glass. Glass core drill bits are worn out quickly and often have reduced service life. The industry continues to demand improved core drill bits, particularly for applications of drilling brittle materials.

### BRIEF DESCRIPTION OF THE DRAWINGS

The present disclosure may be better understood, and its numerous features and advantages made apparent to those skilled in the art by referencing the accompanying drawings.

FIG. 1 includes an illustration of an exploded perspective view of a core drill bit assembly in accordance with an embodiment.

FIG. 2 includes an illustration of a perspective view of a core drill bit assembly in accordance with an embodiment.

FIG. 3 includes an illustration of a front plan view of a core drill bit assembly in accordance with an embodiment.

FIG. 4 includes an illustration of a side plan view of a core drill bit assembly in accordance with an embodiment.

FIG. 5 includes an illustration of a rear plan view of a core drill bit assembly in accordance with an embodiment.

FIG. 6 includes an illustration of a top plan view of a core drill bit assembly in accordance with an embodiment.

FIG. 7 includes an illustration of a bottom plan view of a core drill bit assembly in accordance with an embodiment.

FIG. 8 includes an illustration of a perspective view of a shank for a core drill bit assembly in accordance with an embodiment.

FIG. 9 includes an illustration of a cross-sectional view of a shank for a core drill bit assembly in accordance with an embodiment.

FIG. 10 includes an illustration of a front plan view of a shank for a core drill bit assembly in accordance with an embodiment.

FIG. 11 includes an illustration of a side plan view of a shank for a core drill bit assembly in accordance with an embodiment.

FIG. 12 includes an illustration of a rear plan view of a shank for a core drill bit assembly in accordance with an embodiment.

FIG. 13 includes an illustration of a top plan view of a shank for a core drill bit assembly in accordance with an embodiment.

FIG. 14 includes an illustration of a bottom plan view of a shank for a core drill bit assembly in accordance with an embodiment.

FIG. 15 includes an illustration of a perspective view of a support sleeve for a core drill bit assembly in accordance with an embodiment.

FIG. 16 includes an illustration of a cross-sectional view of a support sleeve for a core drill bit assembly in accordance with an embodiment.

FIG. 17 includes an illustration of a front plan view of a support sleeve for a core drill bit assembly in accordance with an embodiment.

FIG. 18 includes an illustration of a rear plan view of a support sleeve for a core drill bit assembly in accordance with an embodiment.

FIG. 19 includes an illustration of a top plan view of a support sleeve for a core drill bit assembly in accordance with an embodiment.

FIG. 20 includes an illustration of a perspective view of a core tube for a core drill bit assembly in accordance with an embodiment.

FIG. 21 includes an illustration of a cross-sectional view of a core tube for a core drill bit assembly in accordance with an embodiment.

FIG. 22 includes an illustration of a front plan view of a core tube for a core drill bit assembly in accordance with an embodiment.

FIG. 23 includes an illustration of a rear plan view of a core tube for a core drill bit assembly in accordance with an embodiment.

FIG. 24 includes an illustration of a top plan view of a core tube for a core drill bit assembly in accordance with an embodiment.

FIG. 25 includes an illustration of a cross-sectional view of a partially assembled core drill bit assembly in accordance with an embodiment.

FIG. 26 includes an illustration of a cross-sectional view of a fully assembled core drill bit assembly in accordance with an embodiment.

FIG. 27 includes an illustration of a perspective view of a conventional core drill bit assembly.

FIG. 28 includes images of holes drilled according to the performance testing carried out in Example 1.

### DETAILED DESCRIPTION

The following is generally directed to core drill bits that are particularly suitable for cutting brittle materials, such as glass.

Embodiments are directed to a core drill bit assembly having a core tube that can be easily removed and replaced after an abrasive ring of the core tube is no longer providing sufficient abrasion during use. The core drill bit assembly includes a shank in which a support sleeve can be installed and engaged with the shank using a first fastener that extends through a collar of the shank and into the support sleeve. The core drill bit assembly can also include a core tube that can also be installed in the shank around the support sleeve. The core tube can be engaged with the shank and the support sleeve using a second fastener that extends through the collar of the shank, through the core tube, and into the support sleeve. The core drill bit assembly can be particular suitable for operations of drilling glass, such as automobile glass and flat glass, allowing quicker removal and replacement of the core tube after the core tube is no longer useful. The shank and the support sleeve need not be replaced after the core tube is no longer useful. Moreover, replacement of the core tube with the abrasive end only requires partial disassembly of the core drill bit assembly to remove and separate the core tube from the shank.

### Core Drill Bit Assembly

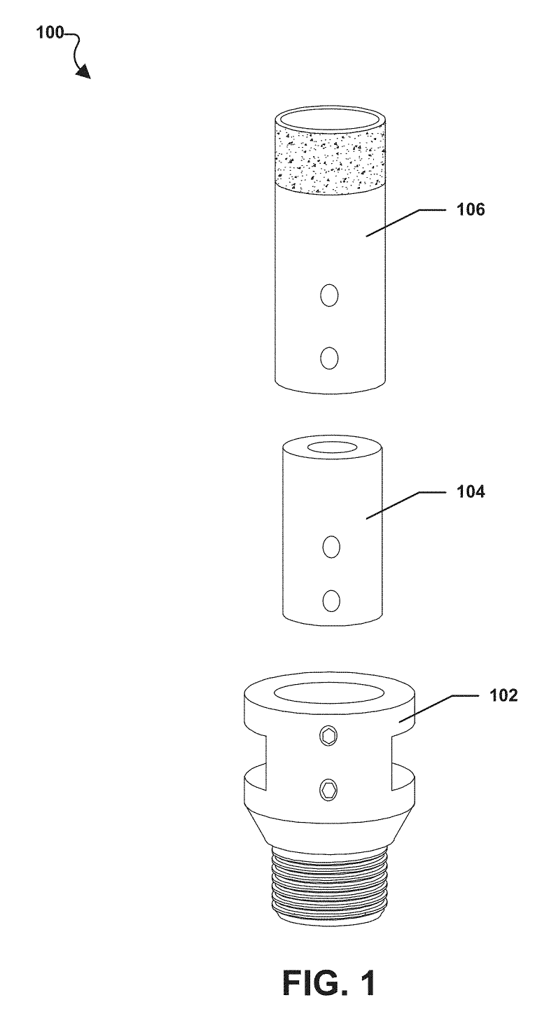

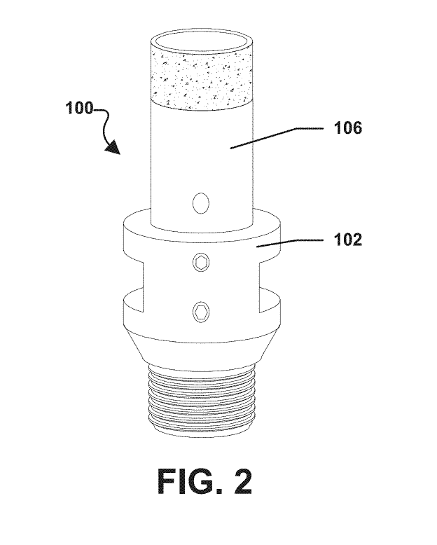

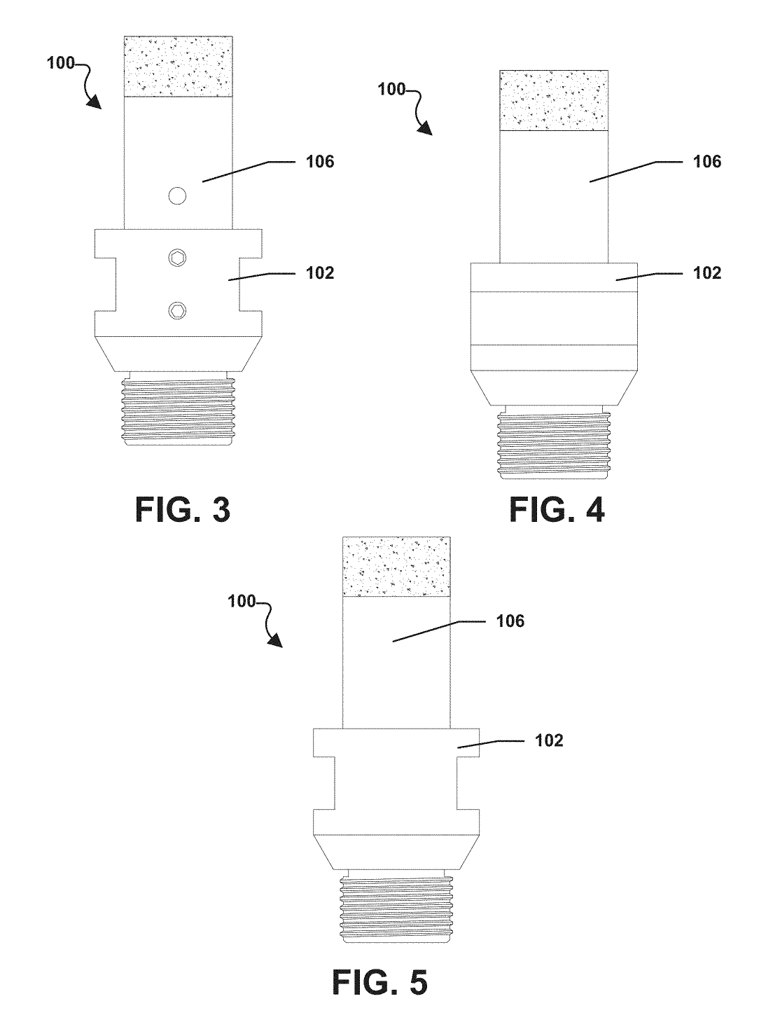

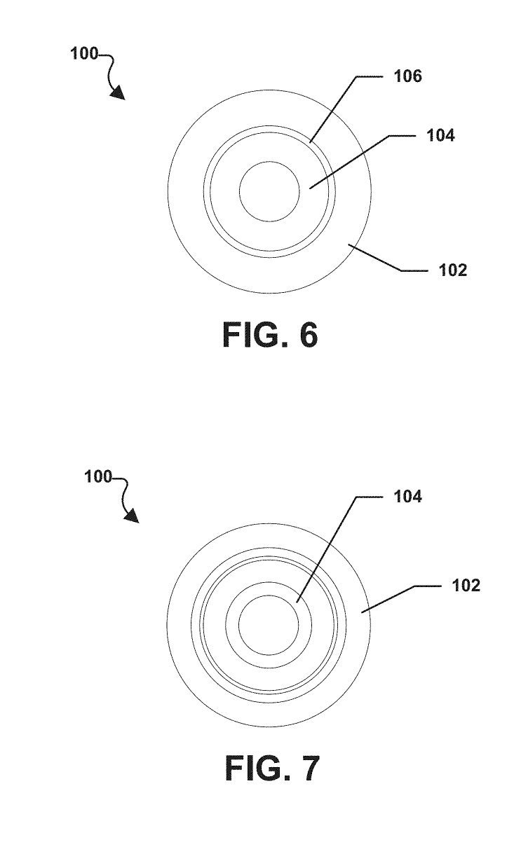

Referring initially to FIG. 1, a core drill bit assembly is illustrated and is generally designated 100. As shown, the core drill bit assembly 100 can include a shank 102, a support sleeve 104, and a core tube 106. As described in greater detail below, the support sleeve 104 fits into the shank 102 and the core tube 106 fits into the shank 102 around the support sleeve 104, as depicted in FIG. 2 through FIG. 7.

### Shank

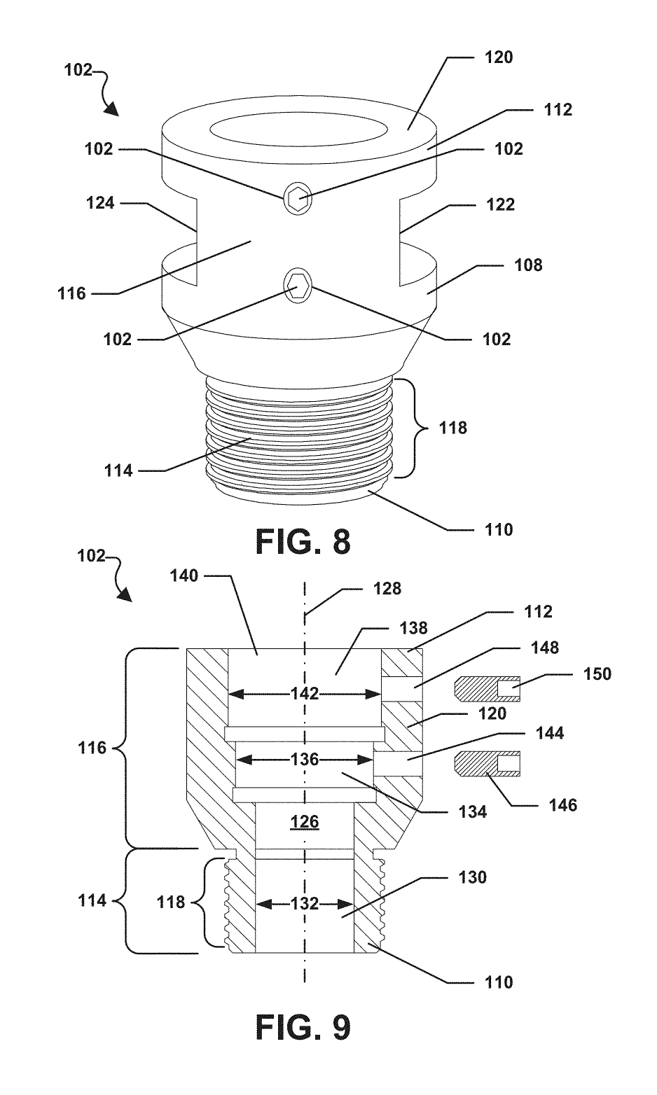

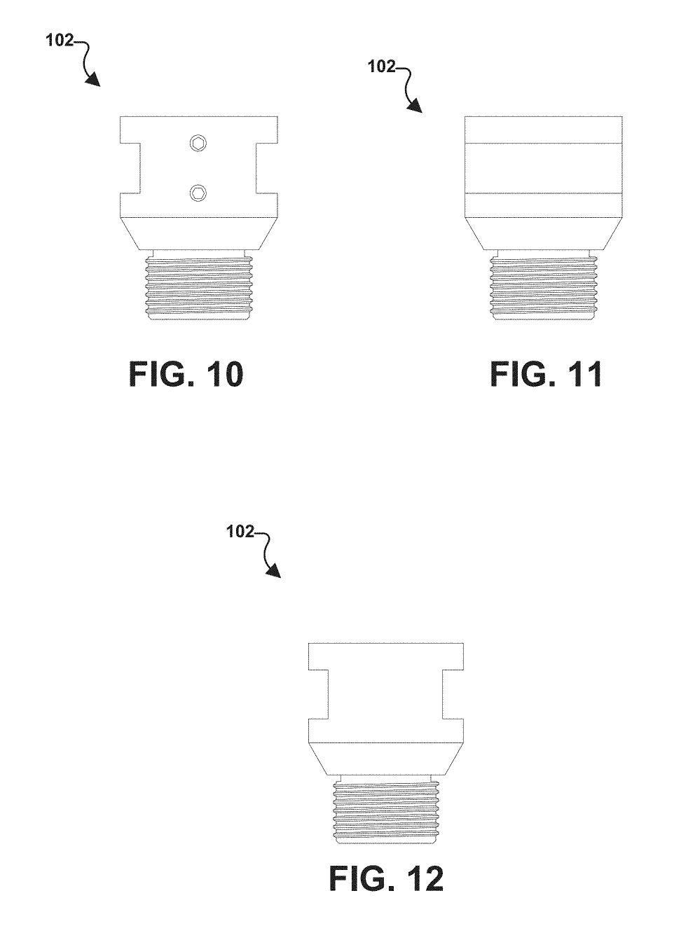

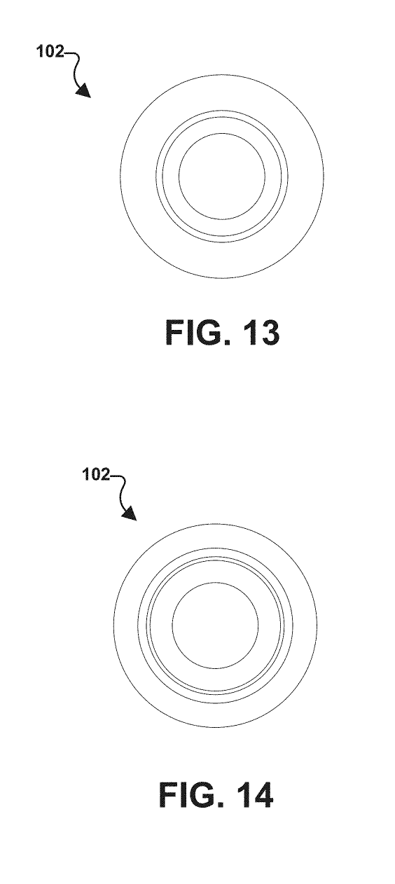

FIG. 8 through FIG. 14 depict the various details of the shank 102 that is configured to receive the support sleeve 104 and the core tube 106. As illustrated, the shank 102 can include a body 108 that can define a proximal end 110 and a distal end 112. Further, the body 108 of the shank 102 can include a base 114 that is adjacent to the proximal end 110. The body 108 of the shank 102 can also include a collar 116 that extends from the base 114 and terminates at the distal end 112 of the body 108. As shown, the base 114 can be formed with a plurality of external threads 118 along the length of the base 114. The external threads 118 can be configured to engage the internal threads of a drive assembly, e.g., a drill chuck (not shown). As illustrated, the body 108 of the shank 102 can include an outer wall 120 that forms the base 114 and the collar 116. The collar 116 can include a first planar surface 122 formed in the outer wall 120 of the body 108 along a portion of the length of the collar 116. Further, the collar 116 can include a second planar surface 124 formed in the outer wall 120 of the body 108 that is diametrically opposed to the first planar surface 122. The planar surfaces 122, 124 are sized and spaced to receive a wrench (not shown) or other similar tool.

FIG. 9 indicates that the shank 102 can include a longitudinal bore 126 formed through the entire length of the shank 102. In a particular aspect, the longitudinal bore 126 can be generally cylindrical and can be formed along a central axis 128 defined by the shank 102. The longitudinal bore 126 can include a fluid transmission portion 130 having a first inner diameter 132. The longitudinal bore 126 can also include a support sleeve engagement portion 134 that extends from the fluid transmission portion 130. The support sleeve engagement portion 134 can include a second inner diameter 136. The second inner diameter 136 may be different from the first inner diameter 132. In particular, the second inner diameter 136 may be greater than the first inner diameter 132. As depicted, the longitudinal bore 126 may also include a core tube engagement portion 138 that extends from the support sleeve engagement portion 134 and terminates at an opening 140 formed at the distal end 112 of the shank 102. The core tube engagement portion 138 may include a third inner diameter 142 that is different from the first inner diameter 132 and the second inner diameter 136. In particular, the third inner diameter 142 may be greater than the first inner diameter 132 and the second inner diameter 136.

As illustrated in FIG. 9, the collar 116 of the shank 102 may include a first radial bore 144 that can extend through the outer wall 120 of the body 108, e.g., within the collar 116, and terminate at the support sleeve engagement portion 134 of the longitudinal bore 126. The first radial bore 144 can be perpendicular to the central axis 128. Moreover, the first radial bore 144 can be threaded and can be configured to receive a first fastener 146. As described in greater detail below, the first radial bore 144 and the first fastener 146 can be configured to allow the first fastener 146 to be threaded into and through the first radial bore 144 so that a portion of the first fastener 146 extends into the support sleeve engagement portion 134 of the longitudinal bore 126. As described in greater detail below, the first fastener 146 is configured to engage the shank 102 and the support sleeve 104 when the core drill bit assembly 100 is fully assembled as shown in FIG. 2 through FIG. 6 and FIG. 26.

Further, the collar 116 of the shank 102 may include a second radial bore 148 that can extend through the outer wall 120 of the body 108, e.g., within the collar 116, and terminate at the core tube engagement portion 138 of the longitudinal bore 126. The second radial bore 148 can be perpendicular to the central axis 128. Moreover, the second radial bore 148 can be threaded and can be configured to receive a second fastener 148. As described in greater detail below, the second radial bore 148 and the second fastener 150 can be configured to allow the second fastener 150 to be threaded into and through the second radial bore 148 so that a portion of the second fastener 150 extends into the core tube engagement portion 138 of the longitudinal bore 126. As described in greater detail below, the second fastener 150 is configured to engage the shank 102, the support sleeve 104, and the core tube 106 when the core drill bit assembly 100 is fully assembled as shown in FIG. 2 through FIG. 6 and FIG. 26.

### Support Sleeve

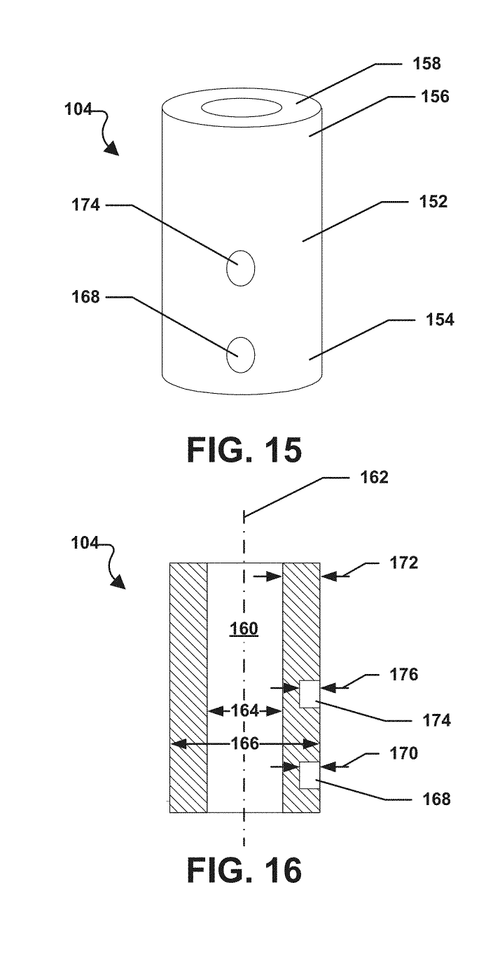

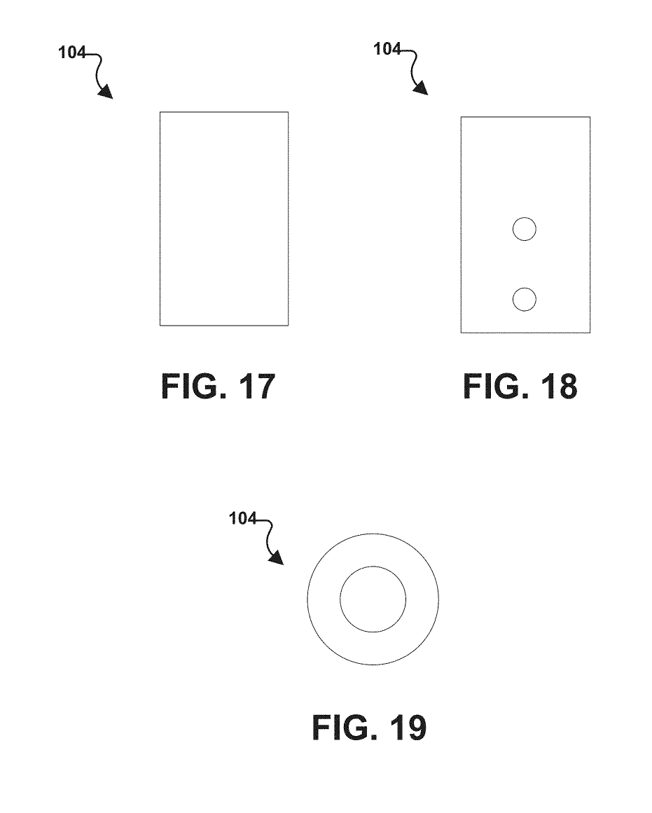

FIG. 15 through FIG. 19 illustrate the details of the support sleeve 104 of the core drill bit assembly 100. As shown, the support sleeve 104 can include a body 152 that can define a proximal end 154 and a distal end 156. Further, the support sleeve 104 can include an outer wall 158 that is generally cylindrical. The support sleeve 104 can also include a longitudinal bore 160 formed along the entire length of the body 152 of the support sleeve 104. In a particular aspect, the longitudinal bore 160 can be generally cylindrical and can be formed along a central axis 162 defined by the support sleeve 104. The longitudinal bore 160 can be circumscribed by the outer wall 158 of the body 152 of the support sleeve 104. The longitudinal bore 160 of the support sleeve can include an inner diameter 164 that is substantially the same along the length of the longitudinal bore 160.

The body 152 of the support sleeve 104 can also include an outer diameter 166. The outer diameter 166 is substantially the same along the length of the body 152. Further, the outer diameter 166 is slightly smaller than the second inner diameter 136 within the body 108 of the shank 102, i.e., within the support sleeve engagement portion 134 of the longitudinal bore 120 formed in the body 108 of the shank 102. As such, the support sleeve 104 can engage the shank 102 in a slip-fit arrangement when the support sleeve 104 is installed within the support sleeve engagement portion 134 of the longitudinal bore 120 formed in the body 108 of the shank 102.

As illustrated in FIG. 15, FIG. 16, and FIG. 18, the body 152 of the support sleeve 104 may include a first radial bore 168 that can extend into, but not through the outer wall 158 of the body 152 of the support sleeve 104. In other words, the first radial bore 168 can include a depth 170 that is less than a thickness 172 of the outer wall 158. The body 152 of the support sleeve 104 may also include a second radial bore 174 that can extend into, but not through the outer wall 158 of the body 152 of the support sleeve 104. In other words, the second radial bore 174 can include a depth 176 that is less than the thickness 172 of the outer wall 158.

### Core Tube

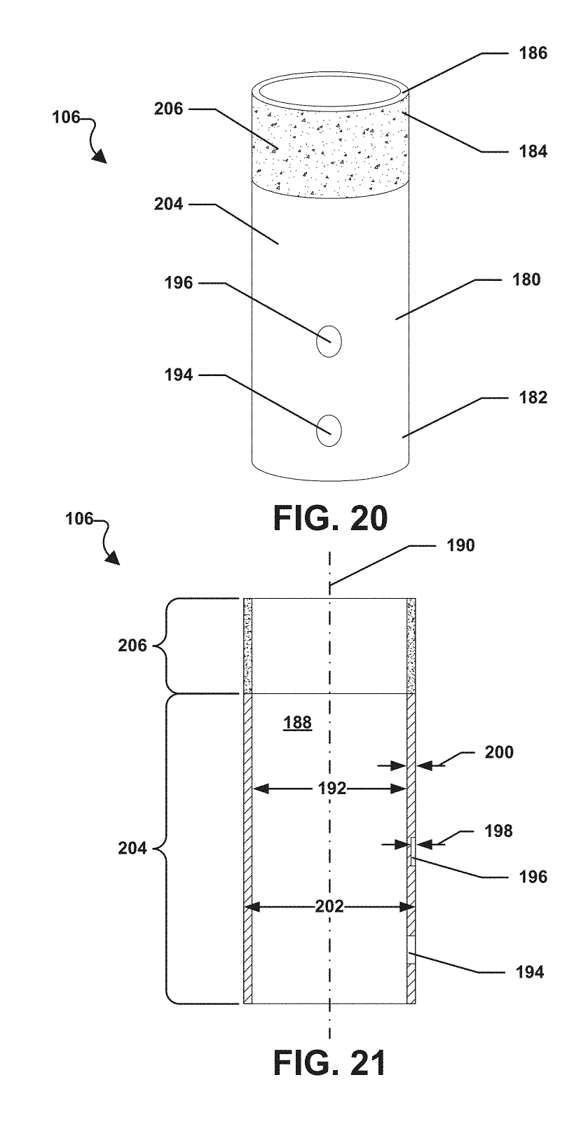

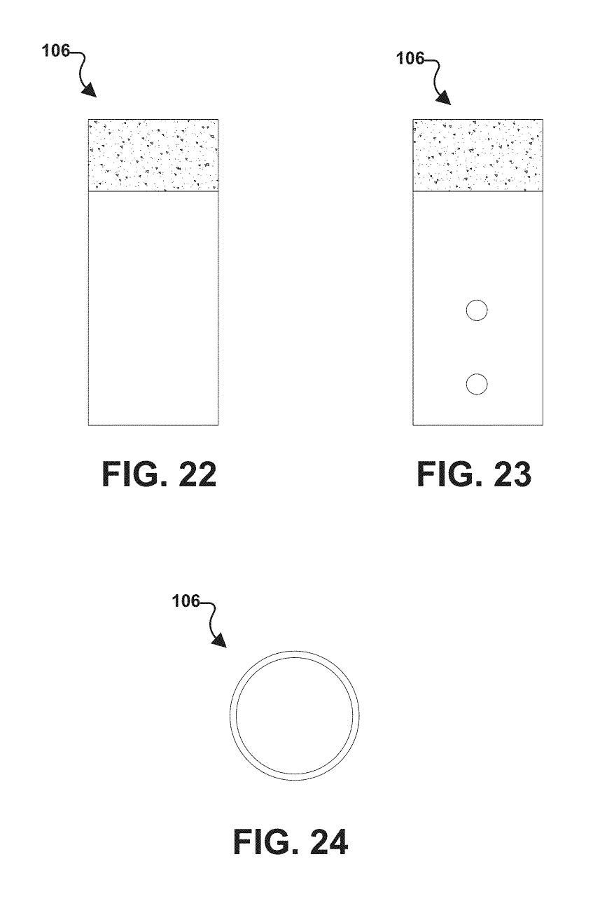

FIG. 20 through FIG. 24 show the details of the core tube 106 of the core drill bit assembly 100. As shown, the core tube 106 can include a body 180 that can define a proximal end 182 and a distal end 184. Further, the core tube 106 can include an outer wall 186 that is generally cylindrical. The core tube 106 can also include a longitudinal bore 188 formed along the entire length of the body 180 of the core tube 106. In a particular aspect, the longitudinal bore 188 can be generally cylindrical and can be formed along a central axis 190 defined by the core tube 106. The longitudinal bore 188 can be circumscribed by the outer wall 186 of the body 180 of the core tube 106. The longitudinal bore 188 of the core tube 106 can include a diameter 192 that is substantially the same along the length of the longitudinal bore 188.

As illustrated in FIG. 20, FIG. 21, and FIG. 23, the body 180 of the core tube 106 may include a first radial bore 194 that can extend through the outer wall 186 of the body 180 of the core tube 106 and terminate at the longitudinal bore 188. The body 180 of the core tube 106 may also include a second radial bore 196 that can extend into, but not through the outer wall 186 of the body 180 of the core tube 106. In other words, the second radial bore 196 within the core tube 106 can extend into an outer surface of the core tube 106 and can include a depth 198 that is less than a thickness 200 of the outer wall 186 of the body 180 of the core tube 106.

The second radial bore 196 within the core tube 106 can function as a core tube alignment mark when a user is installing the core tube 106 over the support sleeve 104 within the shank 102. In other words, since the second radial bore 196 is aligned with the first radial bore 194 along the length of the body 180 of the core tube 104, and the second radial bore 196 remains exposed when the core tube 106 is installed within the shank 102, the second radial bore 196 provides an accurate indication as to the location of the first radial bore 194 that will not be viewable when the core tube 106 is installed within the shank 102.

The body 180 of the core tube 106 can also include an outer diameter 202. The outer diameter 202 is substantially the same along the length of the body 180 of the core tube 106. Further, the outer diameter 202 is slightly smaller than the third inner diameter 142 within the body 108 of the shank 102, i.e., within the core tube engagement portion 138 of the longitudinal bore 120 formed in the body 108 of the shank 102. The inner diameter 192 of the core tube 106 is also slightly larger than the outer diameter 166 of the support sleeve 104. As such, the core tube 106 can engage the shank 102 and the support sleeve 104 in a slip-fit arrangement when the core tube 106 is installed within the core tube engagement portion 138 of the longitudinal bore 120 formed in the body 108 of the shank 102 around the support sleeve 104.

FIG. 20 through FIG. 23 also indicate that the body 180 of the core tube 106 can include a head 204 and a ring 206. In one aspect, the ring 206 is an abrasive ring that includes a plurality of abrasive grains bonded to the body 180 of the core tube 106 in the area of the ring 206. The abrasive grains may be in a single layer or in multi-layers. In another aspect, the ring 206 can be a separate bonded abrasive article that can be brazed, soldered, welded, or otherwise to the head 206 of the body 180. In a particular aspect, the ring 206 can include a bonded abrasive article that includes a plurality of abrasive articles in a bond matrix.

In an embodiment, the bond matrix can include a material including particular composition that can facilitate improved formation, properties, and/or operation of the core drill bit. In an embodiment, the bond matrix can include a metal element, a metal alloy, or a combination thereof. In a further embodiment, the bond matrix can include at least one transition metal element. Particularly, the bond matrix can include an alloy material including at least one transition metal element. For instance, the bond matrix can include a material including Fe. In another instance, the bond matrix can include Fe and an additional transition metal element. The additional transition metal element can include Co, Cu, Zn, Sn, or any combination thereof. In an instance, the bond matrix can include Fe and Cu. In another example, the bond matrix can include a material including Fe, Co and Cu. In still another instance, the bond matrix can include Fe and an alloy, such as bronze or brass. In more particular instances, the bond matrix can include a Co-containing material. The Co-containing material can include Co, Fe, Cu, or any combination thereof. Particularly, the Co-containing material can include an alloy including Co, Fe, and Cu. In some other instances, the bond matrix can include a Co-containing material and an alloy, such as bronze or brass.

In another particular embodiment, the bond matrix may include an impurity, such as C, Ca, Cl, Cr, Mn, Na, Si, or a combination thereof, and the total concentration of all the impurities may not be greater than 1%, such as not greater than 0.5% for the total weight of the bond matrix. According to one aspect, the bond matrix can consist essentially of Co, Fe, and Cu. As used herein, the term, consisting essentially of, is intended to mean not greater than 1% of impurities can be included other than the explicitly included components, which in the bond matrix, are Co, Fe, and Cu.

In an embodiment, the bond matrix can include a particular concentration of Co that can facilitate improved formation, properties, and/or operation of the core drill bit. For instance, the concentration of Co can be at least 5% for the total weight of the bond matrix, such as at least 8%, at least 10%, at least 15%, at least 20%, at least 23%, at least 25%, at least 26%, or at least 27%. In another instance, the concentration of Co can be at most 40%, such as at most 38%, at most 32%, at most 31%, at most 29%, at most 28%, at most 27%, at most 25%, or most 20% for the total weight of the bond matrix. It is to be understood that the concentration of Co in the bond matrix can be within a range including any of the minimum and maximum percentages disclosed herein. For instance, the bond matrix can include a concentration of Co within a range including at least 5% and not greater than 40%, such as within a range including at least 15% and not greater than 29%. In another embodiment, the bond matrix may not include Co.

In an embodiment, the bond matrix can include a particular concentration of Fe that can facilitate improved formation, properties, and/or operation of the core drill bit. For instance, the concentration of Fe can be at least 10% for the total weight of the bond matrix, such as at least 15%, at least 20%, at least 25%, at least 30%, at least 35%, at least 40%, at least 45%, at least 50%, at least 55%, at least 60%, at least 65%, at least 70%, at least 75%, at least 80%, at least 85%, or at least 90 wt %. In another instance, the concentration of Fe can be at most 90%, at most 85%, at most 80%, at most 75%, at most 60%, at most 55%, at most 50%, at most 45%, at most 40%, at most 35%, or at most 30% for the total weight of the bond matrix. It is to be understood that the concentration of Fe in the bond matrix can be within a range including any of the minimum and maximum percentages disclosed herein. For instance, the bond matrix can include a concentration of Fe within a range including at least 10% and not greater than 90%, such as within a range including at least 20% and not greater than 80%.

In an embodiment, the bond matrix can include a particular concentration of Cu that can facilitate improved formation, properties, and/or operation of the core drill bit. For instance, the concentration of Cu can be at least 2% for the total weight of the bond matrix, such as at least 5%, at least 8%, at least 10 wt %, at least 12%, at least 15%, at least 20%, at least 25%, at least 30%, at least 35%, at least 40%, at least 45%, or at least 50 wt %. In another instance, the concentration of Cu can be at most 60%, at most 55%, at most 50%, at most 45%, at most 40%, at most 35%, at most 30%, at most 25%, at most 20%, or at most 15% for the total weight of the bond matrix. It is to be understood that the concentration of Cu in the bond matrix can be within a range including any of the minimum and maximum percentages disclosed herein. For instance, the bond matrix can include a concentration of Cu within a range including at least 2% and not greater than 60%, such as within a range including at least 5% and not greater than 50%.

In an embodiment, the ring 206 can include a particular concentration of the bond matrix that can facilitate improved formation and properties of the core drill bit. For instance, the bond matrix concentration can be at least 85% for a total weight of the first region, such as at least 88%, at least 90 wt %, at least 95%, or at least 99%. In another embodiment, the ring 206 can include a bond matrix concentration of not greater than 99% for a total weight of the ring 206, such as not greater than 95% or not greater than 90%. It is to be understood that the bond matrix concentration can be within a range including any of the minimum and maximum percentages noted herein. For instance, the bond matrix concentration can be within a range including at least 85% and not greater than 99%.

In an embodiment, the ring 206 can include abrasive particles including a superabrasive material. An exemplary superabrasive material can include diamond, cubic boron nitride (cBN), or any combination thereof. In a particular embodiment, the superabrasive material can consist of diamond, cubic boron nitride (cBN), or any combination thereof.

In an embodiment, the abrasive particles can have an average particle size of at least 30 microns, such as at least 35 microns, at least 40 microns, at least 45 microns, at least 50 microns, at least 55 microns, at least 60 microns, at least 70 microns, at least 80 microns, at least 85 microns, at least 95 microns, at least 100 microns, at least 125 microns, or at least 140 microns. In another embodiment, the abrasive particles can have an average particle size of at most 150 microns, such as at most 145 microns, at most 120 microns, at most 110 microns, at most 105 microns, at most 100 microns, at most 95 microns, at most 90 microns, at most 85 microns, at most 80 microns, at most 75 microns, at most 70 microns, at most 65 microns, at most 60 microns, at most 50 microns, at most 45 microns, at most 40 microns. It is to be appreciated that the abrasive particles in the ring 206 can have an average particle size within a range including any of the minimum and maximum values disclosed herein. For instance, the average particle size of the abrasive particles within the ring 206 can be within a range including at least 30 microns and at most 150 microns.

In an embodiment, the ring 206 can include a particular abrasive particle concentration that can facilitate improved formation and properties of the core drill bit. For example, the ring 206 can include an abrasive particle concentration of at least 1% for a total weight of the ring 206, such as at least 3%, at least 4%, at least 5%, at least 6%, at least 8%, or at least 10%. In a further embodiment, the ring 206 can include an abrasive particle concentration of not greater than about 10% for a total weight of the ring 206, such as not greater than about 8%, not greater than about 5% or not greater than about 3%. It is to be understood that the ring 206 can include an abrasive particle concentration within a range including any of the minimum and maximum percentages noted herein. For instance, the ring 206 can include an abrasive particle concentration within a range including at least 1% and not greater than 10% for a total weight of the ring 206.

The ring 206 may have a particular porosity that may facilitate improved formation, properties, and/or operation of the core drill bit. In an embodiment, the ring 206 may have a porosity of not greater than 5 vol. % for a total volume of the ring 206, such as not greater than 4 vol. %, or not greater than 3 vol. %. In another embodiment, the ring 206 can have a porosity of at least 0.2 vol. % for a total volume of the ring 206, such as at least 0.5 vol. %, at least 0.8 vol. %, at least 1 vol. %, at least 1.5 vol. %, or at least 2 vol. % for a total volume of the ring 206. It is to be understood that the ring 206 can include a porosity within a range including any of the minimum and maximum percentages disclosed herein. For instance the ring 206 can have a porosity within a range including at least 0.2 vol. % and not greater than 5 vol. % for a total volume of the ring 206.

In an embodiment, the ring 206 can have a hardness, RH. As disclosed herein, the ring hardness can be measured in accordance with Rockwell hardness scale B, using a load of 100 kgf with a steel sphere indenter having a diameter of 1/16 inches (1.588 mm). In some instances, the hardness RH can be at least 101 HRB, such as at least 102 HRB. In other instances, RH can be at most 110 HRB, such as at most 107 HRB or at most 105HRB. It is to be understood that RH can be in a range including any of the minimum and maximum values disclosed herein. For example, RH can be within a range including at least 101 HRB and at most 110 HRB.

In some instances, RH can be measured in accordance with the Vickers hardness test, using a load of 200 g with a pyramidal diamond indenter. Accordingly, in some embodiments, RH can have a Vickers hardness of at least 260 GPa, such as at least 265 GPa, at least 269 GPa, at least 271 GPa, or at least 273 GPa. In some other embodiments, RH can have a Vickers hardness of at most 298 GPa, such as at most 295 GPa, at most 292 GPa, or at most 286 GPa, or at most 284 GPa. It is to be understood that RH can have a Vickers hardness in a range including any of the minimum and maximum values disclosed herein. For example, RH can be within a range including at least 260 GPa and at most 298 GPa.

In an embodiment, the ring 206 can define an exterior surface region of the core tube 106. In a material removal operation, the exterior surface region of the core tube can be in contact with the workpiece.

### Assembly

The core drill bit assembly 100 can be assembled by first sliding the support sleeve 104 into the shank 102. In particular, the proximal end 154 of the body 152 of the support sleeve 104 can be slid through the opening 140 formed in the shank 102 at the distal end 112 of the body 108 of the shank 102 and into the support sleeve engagement portion 134 of the longitudinal bore 126 formed in the body 108 of the shank 102. As described above, the outer diameter 166 of the support sleeve 104 is slightly smaller than the inner diameter 136 of the support sleeve engagement portion 134 within the shank 102. This allows a slip fit between the support sleeve 104 and the shank 102.

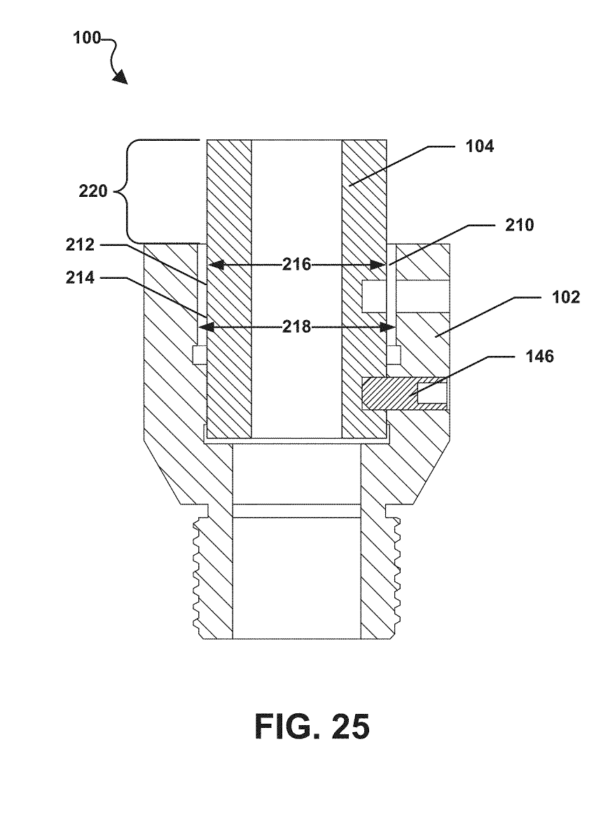

As shown in FIG. 25, the support sleeve 104 can be rotated within the shank 102 so that the first radial bore 168 formed in the support sleeve 104 is aligned with the first radial bore 144 formed in the collar 116 of the shank 102. When the first radial bore 168 of the support sleeve 104 is aligned with the first radial bore 144 of the shank 102, the second radial bore 174 of the support sleeve 104 is also aligned within the second radial bore 148 of the shank 102.

After the first radial bore 168 of the support sleeve 104 is aligned with the first radial bore 144 of the shank 102, the first fastener 146 can be threaded into the first radial bore 144 of the shank 102 until it seats, or is otherwise tightened, within the first radial bore 168 of the support sleeve 104. When the first fastener 146 is properly installed, the support sleeve 104 cannot be disengaged from the shank 102.

As shown in FIG. 25, when the support sleeve 104 is installed within the shank 102, an annular void 210 is established around the support sleeve 104. In particular, the annular void 210 can be formed between an outer surface 212 of the support sleeve 104 and an inner surface 214 of the collar 116 of the shank 102. Moreover, the annular void 210 can includes an inner diameter 216 and an outer diameter 218. The inner diameter 216 of the annular void 210 is the same as the outer diameter 166 of the support sleeve 104. Further, the outer diameter 218 of the annular void 210 is the same as the second inner diameter 136 of the longitudinal bore 126 formed within the shank 102, e.g., within the support sleeve engagement portion 124 of the longitudinal bore 126.

FIG. 25 shows that when the support sleeve 104 is installed in the shank 102, the support sleeve 104 includes an exposed portion 220 that extends from the opening 140 formed in the distal end 112 of the shank 102. The exposed portion 220 of the support sleeve 104 has a length, L_{ES}. In a particular aspect, the L_{ES} may be less than or equal to 60% of the overall length, L_{S}, of the support sleeve 104. In another aspect, L_{ES} may be less than or equal to 55% of L_{S}, such as less than or equal to 50% of L_{S}, less than or equal to 45% of L_{S}, less than or equal to 40% of L_{S}, or less than or equal to 35% of L_{S}. In still another aspect, L_{ES} may be greater than or equal to 10% of L_{S}, such as greater than or equal to 15% of L_{S}, greater than or equal to 20% of L_{S}, or greater than or equal to 25% of L_{S}.

In another aspect, L_{ES} may be less than or equal to 45% of an overall length of the core tube, L_{C}. Further, L_{ES} can be less than or equal to 40% of L_{C}, such as less than or equal to 35% of L_{C}, less than or equal to 30% of L_{C}, or less than or equal to 25% of L_{C}. In another aspect, L_{ES} can be greater than or equal to 10% of L_{C}, such as greater than or equal to 15% of L_{C}, or greater than or equal to 20% of L_{C}.

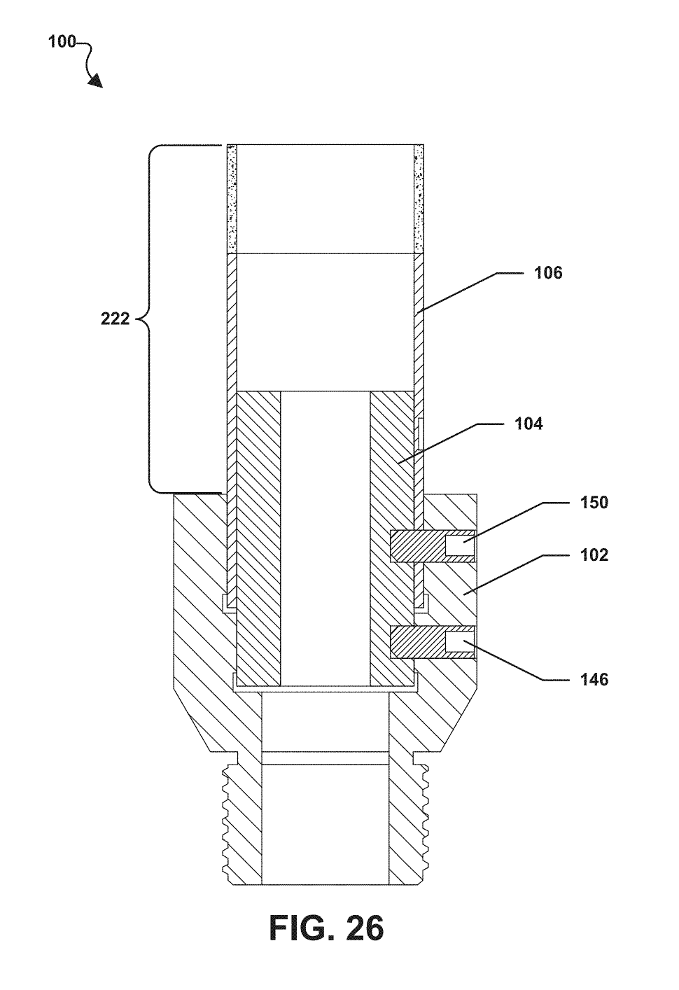

As illustrated in FIG. 26, the core tube 106 is configured to fit into the shank 102 around the support sleeve 104. Specifically, the core tube 106 is configured to fit into the annular void 210 around the support sleeve 104. Further, the proximal end 182 of the core tube 106 is configured to fit into the annular void 210 around the support sleeve 104 so that a portion of the head 204 of the body 180 of the core tube 106 surrounds the support sleeve 104 within the annular void 210 established within the shank 102 between the support sleeve 104 and the shank 102.

The core tube 106 can be rotated until the first radial bore 194 formed in the outer wall 186 of the body 180 of the core tube 106 is aligned with the second radial bore 148 formed in the outer wall 120 of the body 108 of the shank 102, i.e., within the collar 116 of the shank 102. The second radial bore 196 formed within the body 180 of the core tube 106 can be used to facilitate alignment of the first radial bore 194 of the core tube 106 within the second radial bore 148 of the shank 102.

After the first radial bore 194 of the core tube 106 is properly aligned with the second radial bore 148 of the shank 102, the second fastener 150 of the shank 102 can be rotated through the first radial bore 194 of the core tube 106 and into the second radial bore 174 formed in the body 152 of the support sleeve 104 until the second fastener 150 is sufficiently seated, or tightened, within the second radial bore 174 of the support sleeve 104. Once the second fastener 150 is properly installed, the core tube 106 may not be disengaged from the shank 102 and the support sleeve 104.

FIG. 26 shows that after then core tube 106 is installed within the shank 102 around the support sleeve 104, the core tube 106 can include an exposed portion 222. The exposed portion 222 of the core tube 106 can have a length, L_{EC} and L_{EC} can be greater than or equal to 50% of the overall length, L_{C}, of the core tube 106. Further, L_{EC} may be greater than or equal to 55% of L_{C}, such as greater than or equal to 60% of L_{C}, greater than or equal to 65% of L_{C}, greater than or equal to 70% of L_{C}, or greater than or equal to 75% of L_{C}. In another aspect, L_{EC} can be less than or equal to 90% of L_{C}, such as less than or equal to 85% of L_{C}, or less than or equal to 80% of L_{C}.

During use, if the ring 206 of the core tube 106 gets worn down after numerous boring, or drilling, operations, the core tube 106 can be removed from the core drill assembly 100 by loosening the second fastener 150 until the second fastener 150 is clear of the outer wall 186 of the core tube 106. Thereafter, the core tube 106 may be removed from the annular void 210 and disengaged from the shank 102 and the support sleeve 104. The core tube 106 can be replaced with a new core tube (not shown) and installed around the support sleeve 104 and engaged with the shank 102 as described herein

Embodiments herein utilize set screws for engaging the core tube 106 with the shank 102. However, it will be appreciated that other locking mechanisms may be utilized to engage the core tube 106 with the shank 102. In a particular embodiment, the core drill bit assembly 100 may have one fastener, such as two fasteners, three fasteners, or even four fasteners to engage the core tube 106 with the shank 102.

According to certain embodiments, the fastener may comprise a threaded fastener. According to certain embodiments, the threaded fastener can include a rivet. According to still other embodiments, the threaded fastener may include a screw. According to still other embodiments, the threaded fastener may include a nut. According to still other embodiments, the threaded fastener may include a bolt. According to still other embodiments, the threaded fastener may include a washer. According to yet other embodiments, the threaded fastener may include any combination of a rivet, a nut, a screw, bolt or a washer.

According to still other embodiments, other locking mechanisms may be utilized to engage the core tube 106 with the shank 102. According to a particular embodiment, the core tube 106 may be engaged with the shank 102 by means of an expandable high-tension clamp. According to still other embodiments, the core tube 106 may be engaged with the shank 102 by means of a spring mechanism. According to still other embodiments, the core tube 106 may be engaged with the shank 102 by means of a magnetic latch-type mechanism. According to still other embodiments, the core tube 106 may be engaged with the shank 102 by means of a magnetic locking mechanism. According to still other embodiments, the core tube 106 may be engaged with the shank 102 by means of a twist lock mechanism.

When the core drill bit assembly 100 is assembled as illustrated in FIG. 26, the fluid transmission portion 130 of the longitudinal bore 120 formed in the body 108 of the shank 102 is in fluid transmission with the longitudinal bore 160 formed in the body 152 of the support sleeve 104. Further, the longitudinal bore 160 formed in the body 152 of the support sleeve 104 is in fluid transmission with the longitudinal bore 188 formed in the body 180 of the core tube 106. Accordingly, during a drilling, or boring, a fluid, such as a lubricating fluid, can flow through the fluid transmission portion 130 of the longitudinal bore 120 of the shank 102, through the longitudinal bore 160 of the support sleeve 104, and through the longitudinal bore 188 of the core tube 106 in order to provide the fluid to a workpiece to facilitate drilling.

### Examples

The following example includes a description of a core drill bit assembly prepared according to embodiments herein, an example convention core drill bit assembly and comparison of the performance of both assemblies.

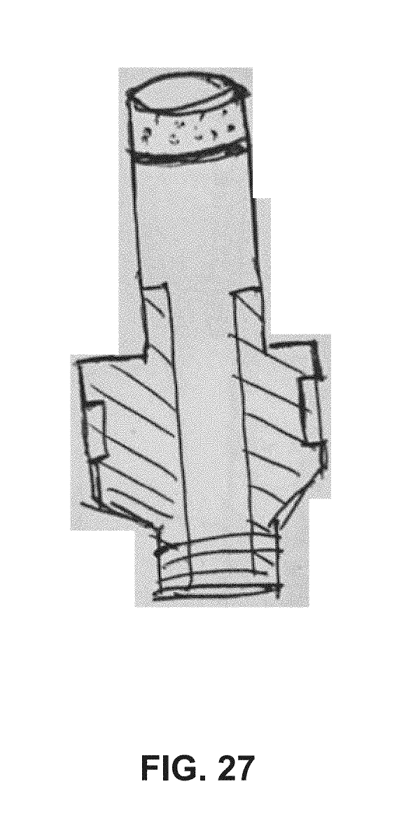

An example core drill bit assembly (S1) as shown in FIG. 2 and an example conventional core drill bit assembly (C1) as shown in FIG. 27 were tested for comparison. The conventional core drill bit assembly C1 uses a core tube that is not removable from the shank. C1 utilized a brazed or welded assembly. Sample S1 utilized two set screws to engage the core tube, support sleeve and shank to form the final core drill bit assembly.

Table 1 summarizes the testing parameters for comparing example core drill bit assembly S1 to the example conventional core drill bit assembly C1.

TABLE 1
Performance Testing
Performance Test Parameters

| Work material | Glass |
|---|---|
| Grinding machine | CNC mill |
| Drill diameter (mm) | 20 |
| Sprindle Speed (r.p.m.) | 4000 |
| Feed (mm/min) | 5-15 |

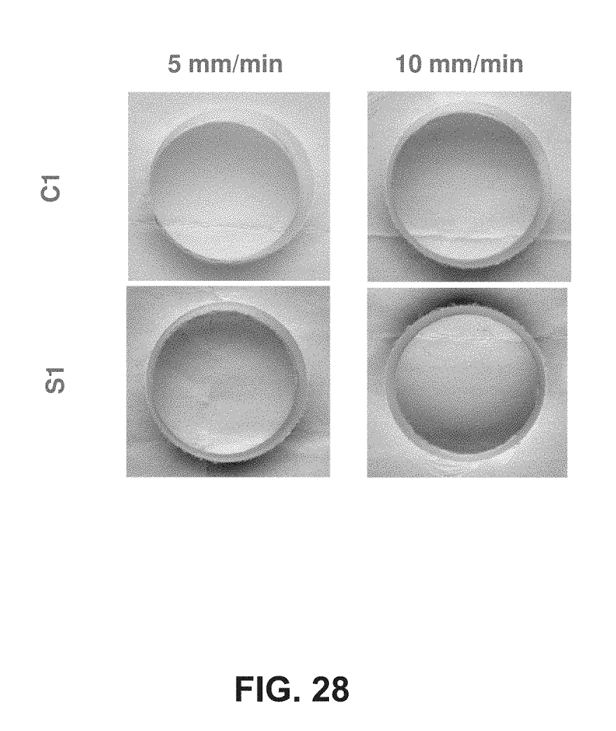

Performance testing was carried out on glass having a thickness of 8 mm. Each core drill bit assembly was used to drill 10 holes at a feed of 5 mm/min and again at a feed of 10 mm/min. The resulting holes are depicted in FIG. 28. No chips in the glass can be seen at an operating distance in the holes drilled with S1 or C1. Chips observed under a lens were in the range of 100-300 microns. Maximum chip size was in a range of 420-450 microns for both S1 and C1.

Sample S1 utilizing the detachable core drill bit assembly according to embodiments herein demonstrated an ability to drill holes comparable to those holes drilled with the conventional drill bit assembly having a brazed or welded assembly that cannot be detached.

Many different aspects and embodiments are possible. Some of those aspects and embodiments are described herein. After reading this specification, skilled artisans will appreciate that those aspects and embodiments are only illustrative and do not limit the scope of the present invention. Embodiments may be in accordance with any one or more of the items as listed below.

### Embodiments

### Embodiment 1

A core drill bit comprising:

a shank;
a support sleeve configured to be disposed within an opening in the shank; and
a core tube comprising a head and a ring, wherein at least a portion of the head is configured to be removably disposed between the support sleeve and the base.

### Embodiment 2

The core drill bit of embodiment 1, wherein the shank comprises a longitudinal bore extending from a proximal end of the shank to a distal end of the shank.

### Embodiment 3

The core drill bit of embodiment 2, wherein the longitudinal bore comprises a fluid transmission portion having a first diameter and a support sleeve engagement portion having a second diameter.

### Embodiment 4

The core drill bit of embodiment 3, wherein the shank comprises a body having a base adjacent to the proximal end of the shank and a collar adjacent to the proximal end of the shank and the collar comprises at least one radial bore extending through an outer wall of the body.

### Embodiment 5

The core drill bit of embodiment 4, wherein the at least one radial bore comprises a first radial bore and the first radial bore extends into the support sleeve engagement portion of the longitudinal bore.

### Embodiment 6

The core drill bit of embodiment 5, further comprising a first fastener configured to engage the first radial bore.

### Embodiment 7

The core drill bit of embodiment 6, wherein the first fastener comprises a rivet, a nut, a screw, a bolt, a washer or any combination thereof.

### Embodiment 8

The core drill bit of embodiment 6, wherein the support sleeve comprises a first radial bore formed in an outer wall of the support sleeve and the first radial bore of the support sleeve is configured to align with the first radial bore of the collar when the support sleeve is disposed within the support sleeve engagement portion of the longitudinal bore within the shank.

### Embodiment 9

The core drill bit of embodiment 3, wherein the second diameter is greater than the first diameter.

### Embodiment 10

The core drill bit of embodiment 9, wherein the longitudinal bore form in the shank further comprises a core tube engagement portion adjacent to the support sleeve engagement portion.

### Embodiment 11

The core drill bit of embodiment 10, wherein the third diameter is greater than the first diameter and the second diameter.

### Embodiment 12

The core drill bit of embodiment 11, wherein the at least one bore further comprises a second radial bore and the second radial bore extends into the core tube engagement portion of the longitudinal bore.

### Embodiment 13

The core drill bit of embodiment 12, wherein support sleeve further comprises a second radial bore formed in the outer wall of the support sleeve and the second radial bore of the support sleeve is configured to align with the second radial bore of the collar when the support sleeve is disposed within the collar of the shank.

### Embodiment 14

The core drill bit of embodiment 13, wherein the core tube comprises at least one radial bore that extends through an outer wall of the body of the core tube.

### Embodiment 15

The core drill bit of embodiment 14, wherein the at least one radial bore of the core tube is configured to align with the second radial bore of the shank and the second radial bore of the of the support sleeve when the core tube is disposed within the collar of the shank around the support sleeve.

### Embodiment 16

The core drill bit of embodiment 15, further comprising a second fastener configured to engage the second radial bore of the shank and the second radial bore of the support sleeve and extend through the at least one radial bore of the core tube.

### Embodiment 17

The core drill bit of embodiment 16, wherein the second fastener comprises a rivet, a nut, a screw, a bolt, a washer or any combination thereof.

### Embodiment 18

The core drill bit of embodiment 16, wherein the core drill bit comprises a third fastener.

### Embodiment 19

The core drill bit of embodiment 18, wherein the core drill bit comprises a fourth fastener.

### Embodiment 20

The core drill bit of embodiment 1, wherein the core tube and the shank are engaged by means of an expandable high-tension clamp, spring mechanism, magnetic-latch-type mechanism, magnetic locking mechanism, twist lock mechanism or any combination thereof.

### Embodiment 21

A core drill bit, comprising:

a shank having a base and a collar extending from the base;
a support sleeve removably engaged with the shank;
an annular void formed within the shank around the support sleeve between an outer surface of the support sleeve and an inner surface of the collar;
a core tube disposed within the annular void; and
at least one fastener, wherein the fastener is configured to engage the shank, the support sleeve, and the core tube to prevent the core tube from moving with respect to the shank and the support sleeve.

### Embodiment 22

The core drill bit of embodiment 21, wherein the collar includes an outer wall formed with a first radial bore and a second radial bore.

### Embodiment 23

The core drill bit of embodiment 22, wherein the support sleeve includes an outer wall formed with a first radial bore and second radial bore.

### Embodiment 24

The core drill bit of embodiment 23, wherein the first radial bore of the collar is aligned with the first radial bore of the support sleeve and the second radial bore of the collar is aligned with the second radial bore of the support sleeve.

### Embodiment 25

The core drill bit of embodiment 24, wherein the core tube includes an outer wall formed with a first radial bore and the first radial bore of the outer wall is aligned with the second radial bore of the collar and the second radial bore of the support sleeve.

### Embodiment 26

The core drill bit of embodiment 21, wherein the at least one fastener comprises a rivet, a nut, a screw, a bolt, a washer or any combination thereof.

### Embodiment 27

The core drill bit of embodiment 21, wherein the at least one fastener comprises an expandable high-tension clamp, spring mechanism, magnetic-latch-type mechanism, magnetic locking mechanism, twist lock mechanism or any combination thereof.

### Embodiment 28

The core drill bit of embodiment 25, further comprising a first fastener that extends through the first radial bore of the collar and into the first radial bore of the support sleeve.

### Embodiment 29

The core drill bit of embodiment 28, wherein the first fastener prevents the support sleeve from moving with respect to the collar.

### Embodiment 30

The core drill bit of embodiment 29, further comprising a second fastener that extends through the second radial bore of the collar, through the first radial bore of the core tube, and into the second radial bore of the support sleeve.

### Embodiment 31

The core drill bit of embodiment 30, wherein the core drill bit comprises a third fastener.

### Embodiment 32

The core drill bit of embodiment 31, wherein the core drill bit comprises a fourth fastener.

### Embodiment 33

The core drill bit of embodiment 30, wherein the second fastener prevents the core tube from moving with respect to the collar and the support sleeve.

### Embodiment 34

The core drill bit of embodiment 23, wherein the core tube comprises a body having a head and a ring, wherein the head of the core tube extends into the annular void.

### Embodiment 35

The core drill bit of embodiment 34, wherein the ring comprises a bonded abrasive article.

### Embodiment 36

The core drill bit of embodiment 35, wherein the bonded abrasive article comprises abrasive particles in a bond matrix.

### Embodiment 37

The core drill bit of embodiment 36, wherein the abrasive particles comprise a superabrasive material.

### Embodiment 38

The core drill bit of embodiment 37, wherein the superabrasive material comprises diamond, cubic boron nitride (cBN), or any combination thereof.

### Embodiment 39

The core drill bit of embodiment 36, wherein the bond matrix comprises a cobalt containing material.

### Embodiment 40

The core drill bit of embodiment 39, wherein the bond matrix includes Co, Fe, Cu, or any combination thereof.

### Embodiment 41

A core drill bit, comprising:

a shank, the shank comprising a body having a base and a collar extending from the base, wherein the collar is formed with longitudinal bore and a first radial bore through an outer wall of the collar and into the longitudinal bore;
a support sleeve disposed within the longitudinal bore, wherein the support sleeve comprises a body having an outer wall formed with a first radial bore that is configured to be aligned with the first radial bore of the collar of the shank;
a fastener removably engaged with the first radial bore of the collar of the shank and the first radial bore of the support sleeve, wherein the fastener is removable to allow the support sleeve to be removed from the shank; and
an annular void formed around the support sleeve within the collar, wherein the annular void is configured to receive a core tube.

### Embodiment 42

The core drill bit of embodiment 40, wherein the collar comprises a second radial bore formed in the outer wall of the collar, wherein the second radial bore is aligned with and space apart from the first radial bore.

### Embodiment 43

The core drill bit of embodiment 42, wherein the support sleeve comprises a second radial bore formed in the outer wall of the support sleeve, wherein the second radial bore of the support sleeve is aligned with the second radial bore formed in the collar.

### Embodiment 44

The core drill bit of embodiment 43, further comprising a core tube disposed within the annular void.

### Embodiment 45

The core drill bit of embodiment 44, wherein the core tube includes an outer wall formed with a first radial bore, wherein the first radial bore of the core tube is aligned with the second radial bore of the collar and the second radial bore of the support sleeve.

### Embodiment 46

The core drill bit of embodiment 40, wherein the core drill bit wherein the fastener comprises a rivet, a nut, a screw, a bolt, a washer or any combination thereof.

### Embodiment 47

The core drill bit of embodiment 45, further comprising a second fastener removably engaged with the second radial bore of the collar, the first radial bore of the core tube, and the second radial bore of the support sleeve.

### Embodiment 48

The core drill bit of embodiment 47, wherein the core drill bit comprises a third fastener.

### Embodiment 49

The core drill bit of embodiment 48, wherein the core drill bit comprises a fourth fastener.

### Embodiment 50

The core drill bit of embodiment 47, wherein the second fastener is removable to allow the core tube to be disengaged from the shank and the support sleeve.

### Embodiment 51

The core drill bit of embodiment 41, wherein the support sleeve comprises an exposed portion that extends beyond a distal end of the shank and wherein the exposed portion includes a length, L_{ES}, that is less than or equal to 60% of an overall length of the support sleeve, L_{S}.

### Embodiment 52

The core drill bit of embodiment 51, wherein L_{ES} is less than or equal to 55% of L_{S}, such as less than or equal to 50% of L_{S}, less than or equal to 45% of L_{S}, less than or equal to 40% of L_{S} or less than or equal to 35% of L_{S}.

### Embodiment 53

The core drill bit of embodiment 52, wherein L_{ES} is greater than or equal to 10% of L_{S}, such as greater than or equal to 15% of L_{S}, greater than or equal to 20% of Ls, or greater than or equal to 25% of L_{S}.

### Embodiment 54

The core drill bit of embodiment 51, wherein L_{ES} is less than or equal to 45% of an overall length of the core tube, L_{C}.

### Embodiment 55

The core drill bit of embodiment 54, wherein L_{ES} is less than or equal to 40% of an overall length of the core tube, L_{C}, such as less than or equal to 35% of L_{C}, less than or equal to 30% of L_{C}, or less than or equal to 25% of L_{C}.

### Embodiment 56

The core drill bit of embodiment 55, wherein L_{ES} is greater than or equal to 10% of L_{C}, such as greater than or equal to 15% of L_{C}, or greater than or equal to 20% of L_{C}.

### Embodiment 57

The core drill bit of embodiment 44, wherein the core tube includes an exposed portion that extends beyond a distal end of the shank and the exposed portion of the core tube includes a length, L_{EC}, that is greater than or equal to 50% of the overall length, L_{C}, of the core tube.

### Embodiment 58

The core drill bit of embodiment 57, wherein L_{EC} is greater than or equal to 55% of L_{C}, such as greater than or equal to 60% of L_{C}, greater than or equal to 65% of L_{C}, greater than or equal to 70% of L_{C}, or greater than or equal to 75% of L_{C}.

### Embodiment 59

The core drill bit of embodiment 58, wherein L_{EC} is less than or equal to 90% of L_{C}, such as less than or equal to 85% of L_{C}, or less than or equal to 80% of L_{C}.

### Embodiment 60

A core tube, comprising:

a cylindrical body defining a proximal end and a distal end, the body comprising: a head adjacent to the proximal end of the body, wherein the head is configured to be installed around a support sleeve within a shank of a core drill bit;
a ring adjacent to the distal end of the body, wherein the body includes an outer diameter that is substantially the same along a length of the body; and
a first radial bore formed in the head of the body near the proximal end of the body, wherein the first radial bore extends through the body and is configured to receive a fastener.

### Embodiment 61

The core bit of embodiment 60, wherein the body includes an inner diameter that is substantially the same along the length of the body.

### Embodiment 62

The core bit of embodiment 60, wherein the ring is formed separately from the head and the ring is permanently affixed to the head.

### Embodiment 63

The core bit of embodiment 62, wherein the ring is brazed to the head.

### Embodiment 64

The core bit of embodiment 60, wherein the ring is integrally formed with the head.

### Embodiment 65

The core bit of embodiment 60, further comprising:

a core bit alignment mark formed in the head of the body adjacent to the first radial bore.

### Embodiment 66

The core bit of embodiment 65, wherein the core bit alignment mark comprises:

a second radial bore formed in the head of the body adjacent to the first radial bore.

### Embodiment 67

The core bit of embodiment 66, wherein the second radial bore extends partially into the body from an outer surface of the body.

### Embodiment 68

The core bit of embodiment 66, wherein the second radial bore is aligned with the first radial bore.

### Embodiment 69

The core bit of embodiment 68, wherein the second radial bore is configured to be visible when the core bit is engaged with a shank and a support sleeve of a core drill bit.

The specification and illustrations of the embodiments described herein are intended to provide a general understanding of the structure of the various embodiments. The specification and illustrations are not intended to serve as an exhaustive and comprehensive description of all of the elements and features of apparatus and systems that use the structures or methods described herein. Separate embodiments may also be provided in combination in a single embodiment, and conversely, various features that are, for brevity, described in the context of a single embodiment, may also be provided separately or in any subcombination. Further, reference to values stated in ranges includes each and every value within that range. Many other embodiments may be apparent to skilled artisans only after reading this specification. Other embodiments may be used and derived from the disclosure, such that a structural substitution, logical substitution, or another change may be made without departing from the scope of the disclosure. Accordingly, the disclosure is to be regarded as illustrative rather than restrictive. Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

The description in combination with the figures is provided to assist in understanding the teachings disclosed herein. The following discussion will focus on specific implementations and embodiments of the teachings. This focus is provided to assist in describing the teachings and should not be interpreted as a limitation on the scope or applicability of the teachings. However, other teachings can certainly be used in this application.

As used herein, the terms “comprises,” “comprising,” “includes,” “including,” “has,” “having” or any other variation thereof, are intended to cover a non-exclusive inclusion. For example, a method, article, or apparatus that comprises a list of features is not necessarily limited only to those features but may include other features not expressly listed or inherent to such method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Also, the use of “a” or “an” is employed to describe elements and components described herein. This is done merely for convenience and to give a general sense of the scope of the invention. This description should be read to include one or at least one and the singular also includes the plural, or vice versa, unless it is clear that it is meant otherwise. For example, when a single item is described herein, more than one item may be used in place of a single item. Similarly, where more than one item is described herein, a single item may be substituted for that more than one item.

Unless otherwise defined, all technical and scientific terms used herein have the same meaning as commonly understood by one of ordinary skill in the art to which this invention belongs. The materials, methods, and examples are illustrative only and not intended to be limiting. To the extent not described herein, many details regarding specific materials and processing acts are conventional and may be found in reference books and other sources within the structural arts and corresponding manufacturing arts.

The above-disclosed subject matter is to be considered illustrative, and not restrictive, and the appended claims are intended to cover all such modifications, enhancements, and other embodiments, which fall within the true scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A core drill bit comprising:
a shank;
a support sleeve configured to be disposed within an opening in the shank; and
a core tube comprising a head and a ring, wherein at least a portion of the head is configured to be removably disposed between the support sleeve and the base.

2. The core drill bit of claim 1, wherein the shank comprises a longitudinal bore extending from a proximal end of the shank to a distal end of the shank.

3. The core drill bit of claim 2, wherein the longitudinal bore comprises a fluid transmission portion having a first diameter and a support sleeve engagement portion having a second diameter.

4. The core drill bit of claim 3, wherein the shank comprises a body having a base adjacent to the proximal end of the shank and a collar adjacent to the proximal end of the shank and the collar comprises at least one radial bore extending through an outer wall of the body.

5. The core drill bit of claim 4, wherein the at least one radial bore comprises a first radial bore and the first radial bore extends into the support sleeve engagement portion of the longitudinal bore.

6. The core drill bit of claim 5, further comprising a first fastener configured to engage the first radial bore.

7. The core drill bit of claim 6, wherein the support sleeve comprises a first radial bore formed in an outer wall of the support sleeve and the first radial bore of the support sleeve is configured to align with the first radial bore of the collar when the support sleeve is disposed within the support sleeve engagement portion of the longitudinal bore within the shank.

8. The core drill bit of claim 1, wherein the core tube comprises at least one radial bore that extends through an outer wall of the body of the core tube.

9. The core drill bit of claim 8, wherein the at least one radial bore of the core tube is configured to align with a second radial bore of the shank and a second radial bore of the of the support sleeve when the core tube is disposed within the collar of the shank around the support sleeve.

10. The core drill bit of claim 9, further comprising a second fastener configured to engage the second radial bore of the shank and the second radial bore of the support sleeve and extend through the at least one radial bore of the core tube.

11. A core drill bit, comprising:
a shank having a base and a collar extending from the base;
a support sleeve removably engaged with the shank;
an annular void formed within the shank around the support sleeve between an outer surface of the support sleeve and an inner surface of the collar;
a core tube disposed within the annular void; and
at least one fastener, wherein the fastener is configured to engage the shank, the support sleeve, and the core tube to prevent the core tube from moving with respect to the shank and the support sleeve.

12. The core drill bit of claim 11, wherein the core tube comprises a body having a head and a ring, wherein the head of the core tube extends into the annular void.

13. The core drill bit of claim 12, wherein the ring comprises a bonded abrasive article.

14. The core drill bit of claim 13, wherein the bonded abrasive article comprises abrasive particles in a bond matrix.

15. The core drill bit of claim 14, wherein the abrasive particles comprise a superabrasive material.

16. The core drill bit of claim 15, wherein the bond matrix includes Co, Fe, Cu, or any combination thereof.

17. A core drill bit, comprising:
a shank, the shank comprising a body having a base and a collar extending from the base, wherein the collar is formed with longitudinal bore and a first radial bore through an outer wall of the collar and into the longitudinal bore;
a support sleeve disposed within the longitudinal bore, wherein the support sleeve comprises a body having an outer wall formed with a first radial bore that is configured to be aligned with the first radial bore of the collar of the shank;
a fastener removably engaged with the first radial bore of the collar of the shank and the first radial bore of the support sleeve, wherein the fastener is removable to allow the support sleeve to be removed from the shank; and
an annular void formed around the support sleeve within the collar, wherein the annular void is configured to receive a core tube.

18. The core drill bit of claim 17, wherein the support sleeve comprises an exposed portion that extends beyond a distal end of the shank and wherein the exposed portion includes a length, L_{ES}, that is less than or equal to 60% of an overall length of the support sleeve, L_{S}.

19. The core drill bit of claim 18, wherein L_{ES} is less than or equal to 45% of an overall length of the core tube, L_{C}.

20. The core drill bit of claim 17, wherein the core tube comprises an exposed portion that extends beyond a distal end of the shank and the exposed portion of the core tube includes a length, L_{EC}, that is greater than or equal to 50% of the overall length, L_{C}, of the core tube.
